(19) United States
(12) Patent Application Publication
(10) Pub. No.: US 2004/0024817 A1
(43) Pub. Date: Feb. 5, 2004

(54) Selectively restricting access of automated agents to computer services

(76) Inventor: Binyamin Pinkas, Jersey City, NJ (US)

Correspondence Address: Binyamin Pinkas, Apt. 2009, 1 River Court, Jersey City, NJ, 07310, US

(21) Appl. No.: 10/622,282

(22) Filed: Jul. 18, 2003

Related U.S. Application Data
(60) Provisional application No. 60/396,957, filed on Jul. 18, 2002.

(51) Int. Cl. H04M 3/00; H04M 5/00; G06F 15/16

(52) U.S. Cl. 709/203; 379/265.09

(57) ABSTRACT

A computerized server selectively accepts service requests from clients connected to it by a communications network. In accordance with the present invention the permission to use a service is contingent on the requesting client performing a task which is easy to perform a limited number of times but is very costly to perform a large number of times. The server receives a service request from a client. The server also receives identifying information of that client, for example caller id information of a telephone number from which the client is further asked to call the server. The server examines data about previous service requests and the corresponding identifying information of clients. The request is approved if the requests with the same identifying information as the current request match a decision criterion for granting the request, for example if the number of these requests is below a predefined threshold.

### CROSS-REFERENCE TO RELATED APPLICATIONS

This application claims the benefit of PPA Ser. No. 60/396,957, filed Jul. 18, 2002 by the present inventor.

### BACKGROUND OF THE INVENTION

Field of Invention

The invention relates generally to accessing systems using a communication network, and more particularly to selectively accepting service requests of a server computer.

### BACKGROUND OF THE INVENTION

We describe the issue of limiting access to computerized services to human users only, rather than to automated agents, detail previous solutions to this problem, and describe how previous solutions are inappropriate for users with disabilities, and are insecure against attackers that employ low paid human users to break them.

In many scenarios services that are offered for human users can be exploited by parties that wish to overuse the available services. These parties (denoted as the “adversary”) typically use an automated device or program (“agent”) that simulates the operation of a legitimate human user. The automated agent can repeatedly simulate the operation of a single, or many, users, asking to use the service. Alternatively, the adversary can employ one or several human users, that repeatedly ask to use the service.

Examples of services that might be exploited by such attacks include:

Account generation: Many services offer free or cheap accounts for users (for example, web services such as Yahoo!, Microsoft Network—MSN, or other portals; web based payment and banking services such as Paypal; web based mail services such as Hotmail; auction services such as eBay, etc.). The intention of the service providers is for every user to open a single account, or very few accounts. An adversary might try, however, to open a very large number of accounts.

URL submission: Search engines (such as Google, Alta Vista, Inktomi, Yahoo and others) enable users to submit urls to be included in the search engine's database. Web spammers might use this feature to submit a very large number of urls, possibly in a specific link structure, in order to boost the ranking of their sites in the search engine's output.

Login: Users that login to their accounts are usually asked to enter a username and a password. Since users might make mistakes while entering their usernames and passwords, they are usually allowed to enter several username/passwords combinations, until they enter a correct pair. An adversary might exploit this feature and try a very large number of usernames and passwords, hoping to guess a combination that lets it use an account it does not own. This attack is known as the “dictionary attack”. The attack is relevant to any service that allows users to access their accounts, including ISPs such as America Online (AOL), MSN, and service providers like Yahoo!, eBay, Hotmail, Paypal, etc.

Mail: Users are typically expected to send a reasonable number of email messages. Spammers send millions of email messages every day, a phenomenon known as spam, exploiting the infrastructure of the electronic mail system.

In order to prevent such abuses, service providers can use computer generated tests that are easy for humans to pass but hard for automated agents. I.e., these tests should be easily solvable by human users but should be impossible, or very hard, for computer programs to solve. These tests were suggested by M. Naor, “Verification of the human in the loop or Identification via the Turing test”, Sep. 13, 1996, http://www.wisdom.weizmann.ac.il/˜naor/PAPERS/human_abs.html, and by U.S. Pat. No. 6,195,698 to Lillibridge et al. (2001). We denote such tests as RTTs (for Reverse Turing Tests).

Users are required to pass an RTT before using the service. This means that an adversary cannot use automated agents in order to abuse the system, since the automated agents cannot pass the RTT. In particular, RTTs can be used to prevent the abuses we described above:

Account generation: A user opening an account should be required to pass an RTT before he or she could use the account.

URL submission: A user submitting a URL to a search engine must pass an RTT before the URL is used by the search engine.

Login: Solving an RTT is a precondition for being told whether any username/password combination is correct or not. This idea was suggested in B. Pinkas and T. Sander, Securing Passwords Against Dictionary Attacks, Proceedings of the ACM Computer and Security Conference, November 2002.

Mail: Solving an RTT is a precondition for sending or delivering email. This could be done by the provider of the mail service (such as Hotmail or Yahoo) requiring users registering for an email service to solve such a RTT before using the service, or solve an RTT if they attempt to send more than a certain number of messages per time period. Alternatively, a recipient of an email message could require senders that it does not recognize to pass such an RTT before reading them. (Simpler challenge response methods for filtering unsolicited mail are weaker since they do not verify that a human user is answering the challenge, and therefore can be thwarted by an automated agent which answers challenges. This applies e.g. to U.S. Pat. No. 6,199,102 to Cobb (2001), U.S. Pat. No. 6,112,227 to Heiner (2000), and U.S. Pat. No. 6,546,416 to Kirsch (2003).)

A typical RTT in use today, and all the RTTs suggested so far (in particular in M. Naor, “Verification of the human in the loop or Identification via the Turing test”, Sep. 13, 1996, http://www.wisdom.weizmann.ac.il/˜naor/PAPERS/human_abs.html, and by U.S. Pat. No. 6,195,698 to Lillibridge et al. (2001)) use properties of human perception in order to design tests which are easy for humans but hard for machines.

The most common test is visual. It displays an image of a distorted word or a sequence of letters, or possibly several such words/sequences, and asks the user to type back all or some of the words/sequences that appear in the image. The distorted rendering of the characters is done in a way that makes it hard for OCR (optical character recognition) programs to decode the images that contain the words/sequences. Such tests are currently being used by Yahoo!, Paypal and AltaVista.

Another variant of an RTT, which is used by Paypal, is based on hearing. The test plays to the user a recording that reads aloud a sequence of letters over a noisy background. The user is required to type back the letters that he or she hears.

The use of RTTs poses two major problems, which are answered by the current invention:

An accessibility problem: People with disabilities find it very hard, or even impossible, to solve the RTT. In particular blind people or even people with minor vision disabilities or dyslexia cannot solve vision based RTTs, although they are able to use computers and access the web (e.g. using a Braille interface or a web site that is designed with accessibility features).

Human adversaries: An adversary might access a service protected by RTTs using human users whose job is simply to solve RTTs. These users could be employed in “sweatshops” of cheap labor workers in a third world country, and could enable the adversary to access the service with a low cost per service request.

The accessibility problem is severe since a considerable percentage of the user population is affected by different disabilities that might prevent them from solving RTTs. Any service provider that attempts to cater for a large user population must provide solutions accessible for people with disabilities.

Indeed, Paypal offers a hearing based RTT to users who have problems solving the vision based RTTs. This solution, however, requires users to have a computer that supports playing the required sound clips (in particular, the computer should have the required hardware, namely a sound card and speakers, and the required media software). Another factor is that people with both vision and hearing disabilities might find it hard to solve any of the tests. Furthermore, the hearing based test must be no easier than the vision based test for automated agents, since otherwise an adversary could design agents that always choose to pass (and break) the hearing based test.

Another method for limiting the access of automated agents to services is to require clients to perform a moderately hard computational task before being allowed to access the service, as suggested by C. Dwork and M. Naor, “Pricing via Processing or Combating Junk Mail”, Proceedings of Crypto '92, pp. 139-147, 1992. This method requires client to perform a task that does not depend on the perceptual capabilities of human users, but rather requires clients to perform a challenge computation that takes, for example, 60 seconds, before being allowed to access the server. The advantage of this method is that the operation of the adversary is delayed, and its throughout of generating new service requests is slowed (e.g. in the above example to one new service per 60 seconds per computer that the adversary uses). The difficulty in using this method is the requirement to install and use special client software, which performs the challenge computation and sends its result to the server. This requirement is rather limiting since in general users are reluctant from installing new software. As a concrete example, web users typically do not approve of installing new software (e.g. a browser plug-in) that is required in order to use a new service. Also, if the user is using multiple machines, such as a desktop, a laptop, a handheld device and occasionally a computer at a friend's house, he cannot be expected to install the required software in all of these locations.

### BACKGROUND OF THE INVENTION

Objects and Advantages

Several of the objects and advantages of this invention are:

(a) To restrict, without the use of RTTs, the access of automated agents to services via a communication network.

(b) To provide a test which distinguishes between automated agents that perform a large number of service requests, and a human user or an agent that ask a small number of requests.

(c) To provide a test which is easily solvable by users with disabilities, while preventing automated agents from passing the test a large number of times. This approach is preferable to the use of RTTs since those tests are based on human perception and therefore are very hard for users with disabilities and prevent these users from accessing the protected services.

(d) To provide such a test that does not require clients to install any special client software.

(e) To prevent human based attacks on service protected by RTTs, where adversary uses human users whose job is to solve RTTs which are served by the service provider.

Further objects and advantages will become apparent from a consideration of the ensuing description and drawings.

### SUMMARY

In accordance with the present invention the permission to use a service is contingent on the requesting client performing a task which is non-scalable, i.e. a task which is easy to perform a limited number of times but is very costly to perform a large number of times. The task does not depend on perceptual capabilities and does not require installation of new software.

### BRIEF DESCRITPIONS OF THE DRAWINGS

FIG. 1 is a block diagram of of clients and servers that use the invention and a communications network connecting them.

FIG. 2 is a block diagram of clients and servers that use the invention, a communications network connecting them, and a client identifying communications network connecting them.

FIG. 3 is a block diagram of clients and servers that use the invention and a client identifying communications network connecting them.

FIG. 4 is a flow diagram of the preferred service request protocol.

FIG. 5 is a flow diagram of a preferred process that generates the result of the service request protocol.

FIG. 6 is a flow diagram of an alternative process that generates the result of the service request protocol.

### DETAILED DESCRITPION OF THE PREFFERED EMBODIMENTS

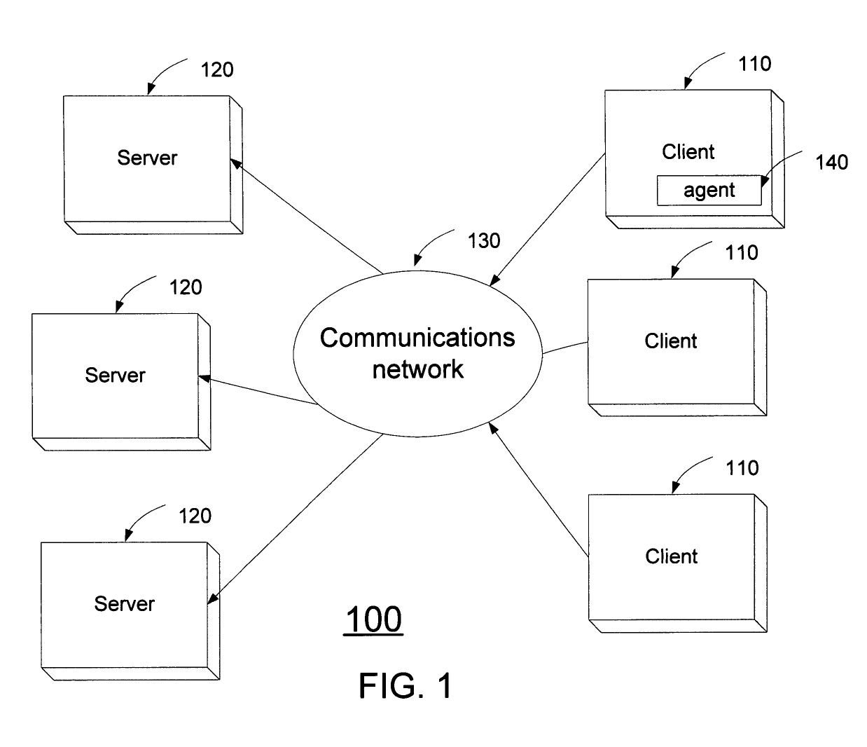

The invention is applied, as shown in FIG. 1, to a network of computers 100 that includes many client computers 110 and many server computers 120, which are connected by a communications network 130 such as the Internet. The client computers can be personal computers, hand held computers, personal digital assistants (PDAs), cellular phones, or any other computational device. Similarly, the server computer could be any computation device, but typically the server computer is usually a larger computer system, possibly a set of such computer systems that appear to be the same unit to clients connecting to them via the communications network.

A client user can design an automated process (agent) 140 that can perform many interactions with the server computers. For example, if the server offers users a service of email accounts the agent could be used to open a very large number of different user accounts.

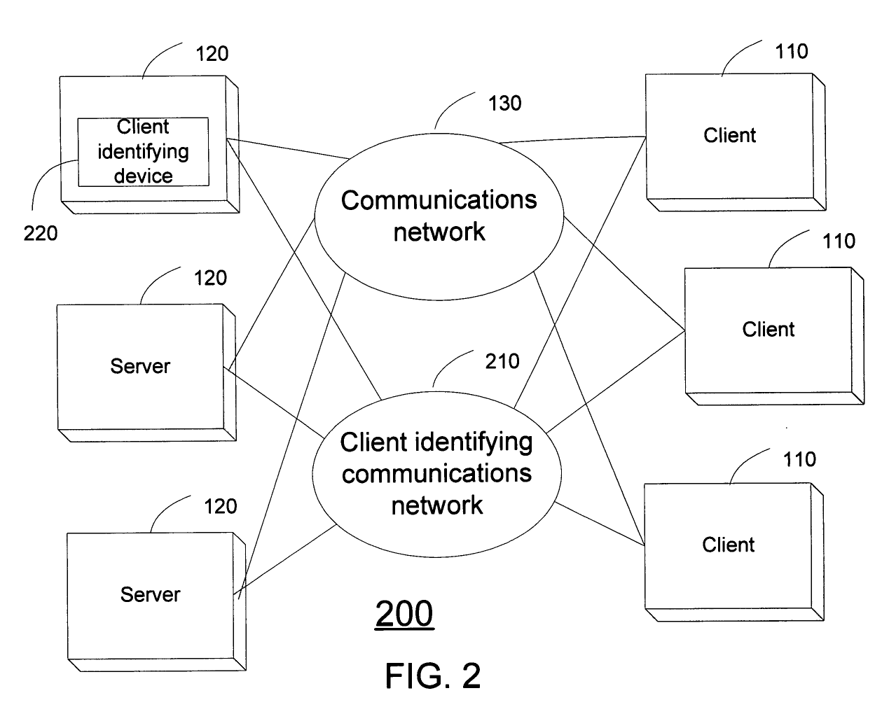

FIG. 2 shows 200 same clients and servers, connected using same communications network and also using a different client identifying communications network 210. The client identifying communications network enables servers to identify the identity of clients that are connecting to them. An example of such network is the telephone network that provides recipients of telephone calls with caller id information. A server which receives a connection via client identifying communications network can operate a client identifying device 220 that provides it with identifying information of the client that contacts it. For example, in the case of a telephone network, a caller id device provides the recipient of a phone call with the telephone number of the calling party.

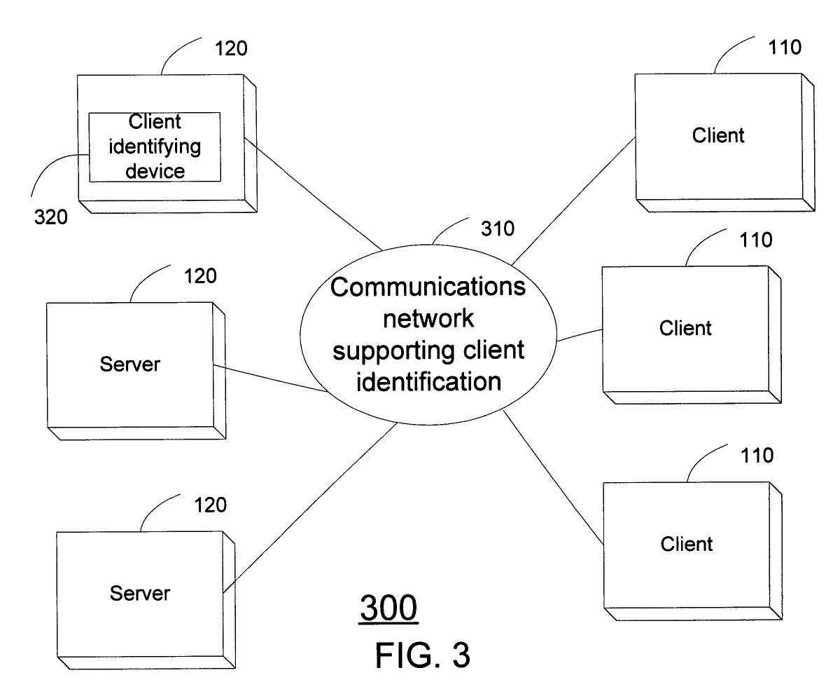

FIG. 3 shows same clients and servers, connected using a single communications network that supports client identification 310. The servers might identify clients using a special client identifying device 320, or they might be able to identify the clients using the properties of the communication protocol. An example of such a network is a local area network where clients are identified by their IP address, a web network where clients are identified using cookies, or a network where clients use special hardware devices, such as special secure chips or smartcards, that identify them to servers.

Operation

In order to prevent automated agents from using the service a large number of times, and instead of using RTTs that are based on the perceptual capabilities of humans, we suggest to require users to perform a task that can be easily done a limited number of times, but is very costly to perform a large number of times. We call such a task an NST (Non-Scalable Task).

Note that it might be possible for the adversary to perform an NST a limited number of times. However, for the purpose of the service providers it suffices that the adversary cannot perform the task a large number of times. This is certainly sufficient for each of the example applications given above. Furthermore, an adversary that uses human agents can easily pass a considerable number of RTTs by forwarding them to the human agents, but might find it hard to perform the same number of NSTs.

As a warm-up we describe an example of a bad NST (Non-Scalable Task): A simple implementation of an NST could require users who are not capable of passing the RTT to call a customer service center and speak with a human operator that verifies that they are human. Once calling the center and speaking with the operator the users are granted access to the desired service. This customer service based NST can be used as a complete replacement for RTTs, or be used only for users that find it hard to pass the RTT (for example, next to the RTT there could be a “help” link that provides information about the NST). The major drawback of this solution is the high cost of answering customer service calls, which is estimated at more than $25 per call. This cost makes it non-economical to use this solution for virtually any type of service. In addition this solution is insecure since an adversary could use human agents that call the customer service many times and perform a large number of NSTs.

The preferred embodiment uses client identifying features of a communications network. In particular, we describe it using the caller-id features of the telephone system but it could also be applied to other forms of client identification on different types of networks.

The preferred embodiment is based on the fact that every client typically has access to a phone line, which is easy for the user to use and which is already paid for. On the other hand, an adversary who wants to use automated agents to access services might have access to a considerable number of phone lines, but the cost of registering and maintaining each line is non-negligible. The NST is based on conditioning access to the service on the ownership of a phone line, and limiting the number of NSTs that can performed from any single phone line. The NST is useful if the cost of registering and maintaining a phone line is much higher than the benefit the adversary gains from one “use” of the service.

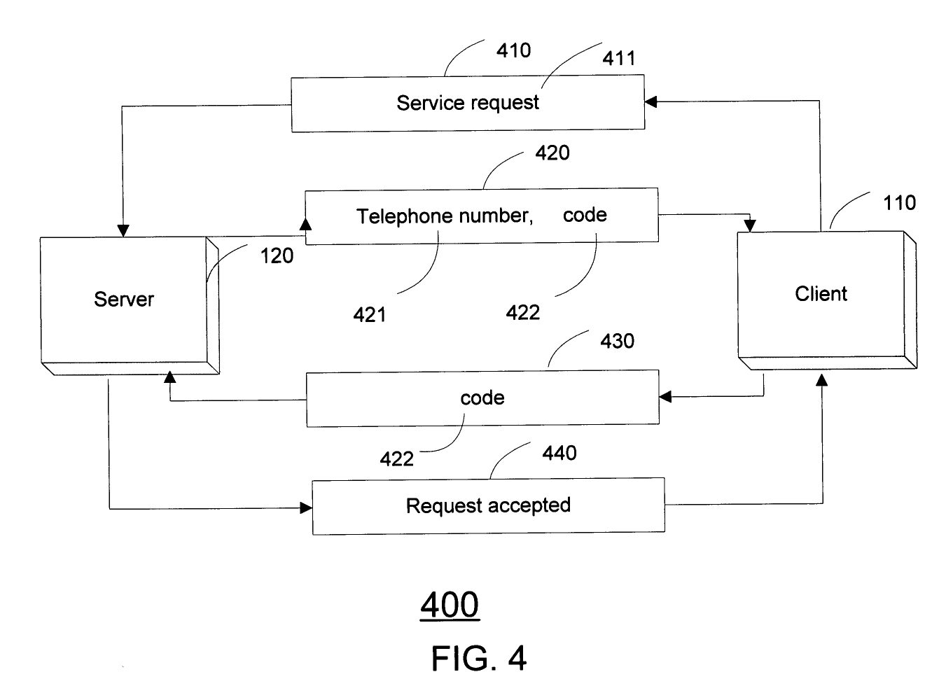

FIG. 4 shows the message flow in the operation of a basic NST (Non-Scalable Task) based on caller id.

(a) In message 410 the client 110 sends a service request 411 to the server 120.

(b) In message 420 the server sends displays to the client a phone number 421 to call (preferably a toll-free number), and possibly a short sequence of several digits or characters (a “code”) 422. The combination of the phone number and code should preferably be unique for every user.

(c) In message 430 the client, or a user that operates the client calls the displayed telephone number 421, and once answered type/key the code (sequence of digits or letters) 422 (encoded as digits in the standard phone dialer way) that was displayed to him.

(d) In step 440, if the decision is to accept the service request, the server notifies the client that the request is accepted.

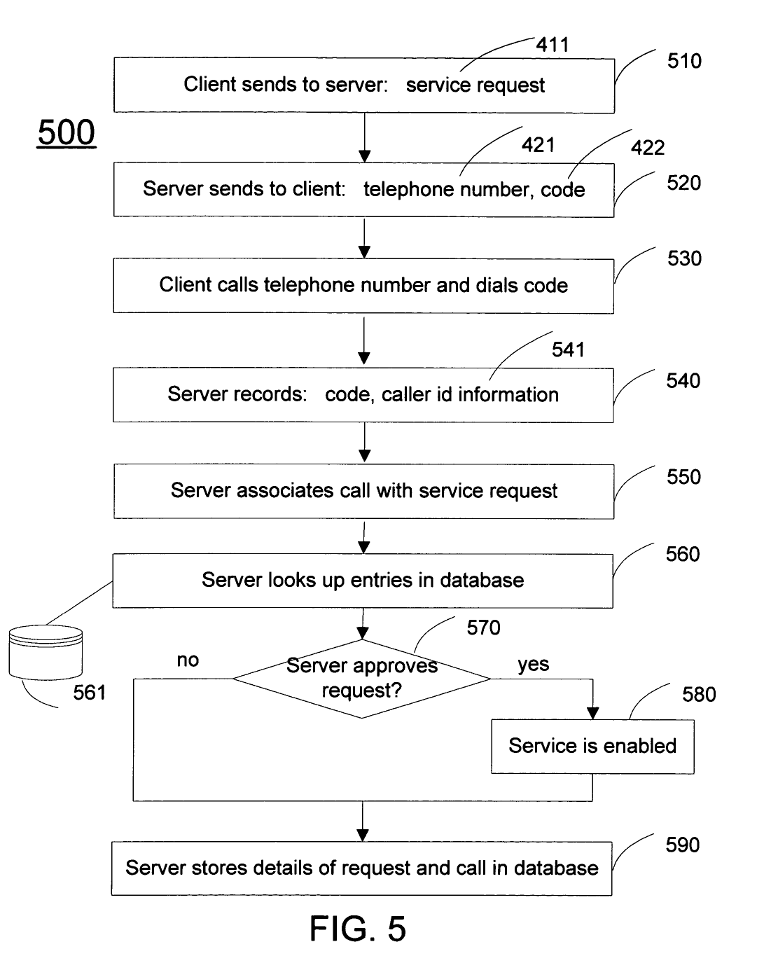

FIG. 5 shows the operation of a basic NST (Non-Scalable Task) based on caller id.

(e) In step 510 the client 110 sends a service request 411 to the server 120. As a response the two parties run the following procedure.

(f) In step 520 the server displays to the user a phone number 421 to call (preferably a toll-free number), and possibly a short sequence of several digits or characters (a “code”) 422. The combination of the phone number and code should preferably be unique for every user.

(g) In step 530 the client, or a user that operates the client calls the displayed number 421, and once answered type/key the code (sequence of digits or letters) 422 (encoded as digits in the standard phone dialer way) that was displayed to him.

(h) In step 540 the server 120 (or a program or device operating for it) records the caller id information 541 of the number from which the call was generated.

(i) In step 550 the server associate the call to a service request 411 based on the telephone number that was called 421, the code 422 that was dialed by the caller, and the time, to which.

(j) In step 560 the server uses the caller id information 541 to look up entries in a database 561 of phone numbers from which previous NSTs were answered.

(k) In step 570 the server decides, based on the information gathered in step 560 and type of service request 411 whether to accept the service request. The decision procedure could be, for example, to enable every phone line to be used for only a single service request in every day. That is, if the called id information 541 is associated in the database 561 with a service request that happened in the same day as the current service request 411, then the current service request 411 is denied. (Other decision procedures are described below.) Since the telephone network provides the caller id information even before the phone call is answered, the decision can be made either before the call is answered, or afterwards. The server might even make the decision without answering the call.

(l) In step 580, if the decision is to accept the service request, the service is enabled to the user with whom the NST was associated.

(m) In step 590, the server stores in database 561 the details of the current call, i.e. its time and date, the service request, and the caller id information.

The above description of the preferred embodiment should not be construed as a limitation on the scope of the invention, but rather as an exemplification of one preferred embodiment thereof. Many other variations are possible. Each of these variants could be used by itself, or alternatively a combination of these variants can be used.

We first describe here examples of variations of embodiments that are based on a communications network that verifies the client identity, e.g. a telephone network. (Later we describe examples of embodiments that are not based on a communications network that verifies the client identity.)

(a) The server could require clients to pass an NST whenever they ask for a service request. Alternatively the server could first send an RTT (Reverse Turing Test) to the client and ask the user operating the client to solve it. A link that is easily accessible for those viewing the RTT refers users who have problems using the RTT to an NST. (The link should be displayed in a way that is visible for people with disabilities.)

(b) Once the client is given an NST, it might be given a time frame in which it must answer the NST (say, 5 minutes, an hour, a day or a week). If the NST is not answered within this timeframe then the service request is not enabled.

(c) The decision procedure that decides whether to accept a call based on a phone line's caller id information can be a function of many parameters, including but not limited to the previous calls made from the phone line to the server and the times in which these calls were made, the time and date of the call, the party to which the number is registered (e.g. depending on whether the line is registered to a private person or to a business), the experience the service had with previous callers from that number, the service that is being requested, etc. For example, the decision procedure could be that a private phone number could be used to enable at most two service requests in every 24 hour period, whereas a business phone number could be used to enable five requests in a 24 hour period, but only during the work week (and possibly a larger business, which has many workers and is considered respectable, could be allowed a larger number of NSTs).

(d) The decision procedure could achieve enhanced user-friendliness and accessibility by allowing users to make a small number of mistakes when dialing the required code. For example, a user who is asked to dial the sequence “12345” could be given access to the service even if the sequence that is dialed is different by at most one digit from the target sequence “12345”, or is a sequence with an edit distance of at most 1 from “12345”. In that case the service request is enabled even if the client dials, for example, the code “12349”. By making sure that any two sequences that are assigned to different users have a large Hamming distance or edit distance, we can make sure that this feature results in at most a negligible degradation in the security of the system.

(e) The phone number and the code that should be dialed to identify the user will typically be displayed to the user using legible fonts, and using measures that make it possible for people with vision or reading disabilities to read the numbers. There could also be an option to read aloud these numbers to the user.

(f) The system could use a large number of phone numbers answering calls by clients, and identify users by the number to which they are required to call. In this case the system can operate without requesting users to type a special code to identify their request. For example, clients could have a five minute period in which they are required to make a call to answer the NST. A dedicated telephone number is associated with each NST for the period in which it should be answered.

(g) There are several ways for the service provider to obtain the caller id information. It could use the CNID (Calling Number Identification) field that is used by home caller-id systems. The drawback of using this field is that there are ways for the originators of the calls to spoof this field, essentially enabling them to decide what caller-id value is displayed to the recipient of the call. This feature might enable an adversary to break an NST system. An alternative method of obtaining caller id information is using the ANI (Automatic Number Identification) field. The ANI field of incoming calls is available for the owners of toll-free numbers. This method is more secure since there are no known ways of spoofing the ANI field.

(h) There is no need for the server to keep records that associate clients with phone numbers from which they made their NST calls. Although such records could be useful for risk management, the basic operation of the server only requires records of phone numbers from which NSTs were performed in the past, and there is no need for the associated client information. The server could therefore not store records that associate clients with phone numbers, and by doing that enhance the privacy of the clients.

(i) If the client connects to the Internet using a telephone line, and the service provider has a relationship with the ISP that is used by the user (or possibly, the service provider is the ISP, e.g. AOL or MSN), then the caller-id information can be available to the service provider through its relationship with the ISP. In this case it might not be required to ask the user to call a special telephone number to perform the NST. As an example, one possible implementation is for the service provider to keep a database of telephone numbers that were previously used by users to connect to the Internet while they were requesting the service. Each telephone number could have a bound on the number of users that can use it to receive the service (for example, MSN could keep a record of the number of Hotmail accounts that were opened by MSN subscribers that used a dial-in access number). Of course, the bound could depend on other parameters, as discussed above. If the service is requested from a number that has not passed its bound then the service is enabled, otherwise the user is required to use a different type of NST to enable the service, such as a caller-id based NST that requires the user to call a different phone number. A different implementation could associate phone numbers with users, under the constraint that not too many users are associated with each phone number, and vice versa. Users can use the service if they access it from a phone number that is associated with them. If they use a different phone number, they are required to perform an NST (for example, the NST based on the caller-id information available to the ISP, which is described in this paragraph, or the caller-id based NST that requires users to call a special number for the purpose of the NST).

A particular issue arising when clients are required to use solutions based on caller id information involves with clients that are using a dial-in service to connect to the service (or to the Internet). This means that at the time they are asked to call a number in order to perform an NST, their phone line is busy since it is being used to access the service. There are several solutions for this scenario, which can be used alone or in combination with each other or with other solutions:

(a) If the client has access to several phone lines, or a mobile phone, it could use one line to call the NST, even if he uses one line to connect to the Internet/service.

(b) The client could hang-up its current connection, call the NST number, and then reconnect to the service provider. The system could be designed to make this operation as seamless as possible, for example by the service provider storing the state of the client at the time he hangs up, and restoring that state when the user reconnects.

(c) The system could give the client a time frame during which it can make the call (for example, one day). The client could continue the interaction with the service provider, or the Internet session, and call the NST number afterwards. In the meantime the server could give the client a status that enables limited access to the service, to limit the abuse that can be done by an adversary that uses this feature.

(d) If the service provider has a relation with the ISP that the client uses to connect to the Internet/service, it could use the caller-id information that is available to the ISP for the purpose of the NST. In other words, when the client attempts to use the service the service provider could already know the caller-id information, or it could ask for it from the ISP. In that case the NST could be implicitly implemented, and there might not be any need to require the user to call a special number for the purpose of the NST.

(e) Note that in many applications an NST is only required in the first time that the client is accessing the system. After the initial session the service provider can store an “Enable” state related to the user (e.g. using a cookie in the user's machine, or in a database stored by the service provider), in future connections this state is used to verify that the client is allowed to use the service. The fact that NSTs are only required in the first connection make it more acceptable to require the user to use a phone line to perform the NST.

Additional Embodiments

The additional embodiments are not on using caller-id information. Each embodiment could be used by itself, or a combination of them, possibly together with a caller-id based embodiment, could be used by the same server.

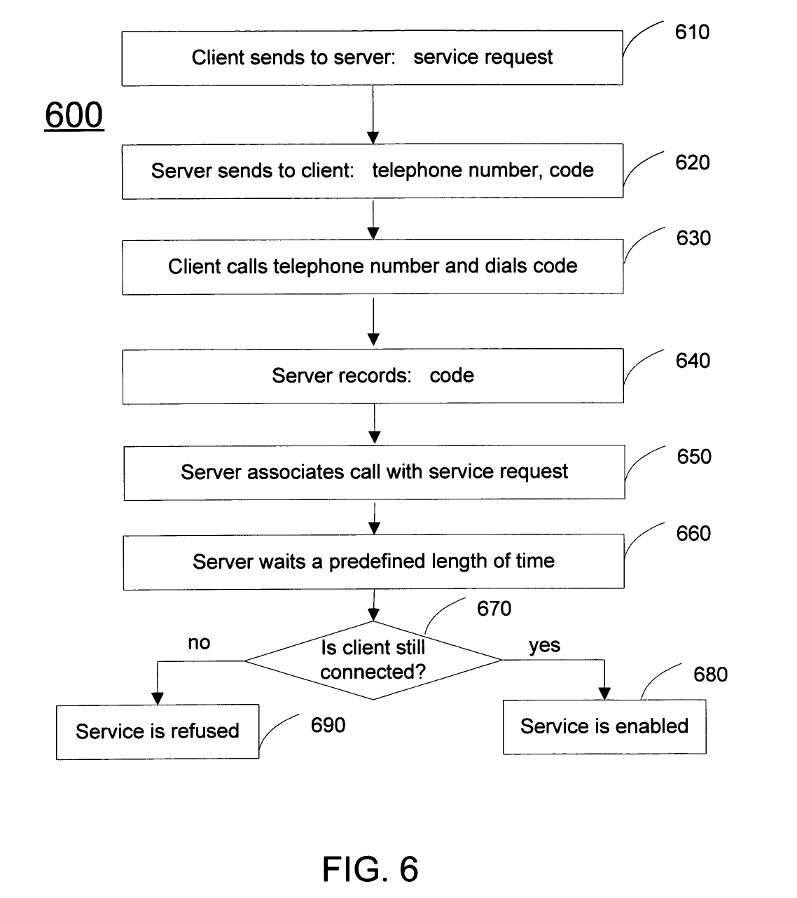

An additional embodiment is illustrated in FIG. 6. In step 610 the client sends a service request to the server. In step 620 the server presents to the client a phone number and possibly a code (i.e. a sequence of digits or letters). Each pair consisting of a phone number and a code should preferably identify a single service request during a specific time frame. In step 630 the client calls the phone number and dials the code. In step 640 the server records the dialed code. In step 650 the server uses the dialed code and the phone number to which the client dialed, to associate the call with the service request made in step 610. Note that the service provider does not check the caller id information of incoming calls, but rather only examines the dialed number and the code. In step 660 the server waits a certain predefined, non-negligible, length of time (e.g. five minutes). After that, in step 670 the server checks whether the client is still connected. If this is the case, then in step 680 the server approves the request. Otherwise in step 690 the server refuses the service request. This procedure reduces the rate with which the adversary can use the service (e.g. to one time every five minutes for every phone line it uses), and might therefore be sufficient for the purpose of the NST (Non-Scalable Task). (In fact, this feature could also be used together with the caller-id based NSTs.)

In one possible variation of this method the server might choose to make a decision whether to approve the service based on the phone number that was dialed, and the dialed code alone. A possible security problem with this method is that it might be easy for an adversary to make these calls in the same way that users perform them, using a limited number of phone lines.

A further possible variant is for the server to require the client to first call a certain phone number and possibly type a certain code. After performing this task a voice at the other end of the line (preferably one that is generated in an automated way and is incomprehensible for automated programs, and preferably with an option to use one of several languages) could ask the user to type some other code. If the user performs this task then the service that is associated with the phone number/code pair is enabled. (Compared to a hearing based RTT that is given to users via their computers/devices, this test has the advantage that there is no need for special hardware/software at the user side for playing the voice instructions.) This method can also serve as an RTT.

A further possible variant is for the server to require the client to first call a certain phone number and possibly type a certain code. After performing this task the user is required to speak and say some words that are given to him by the service provider (the words can either be given to the user online or read via the phone line). The service provider could check whether the voice used by the user is a human voice or an automated voice, and only enable the service if the voice is human. The service provider could also keep a database of “fingerprints” of voices that were used in the past to enable the service, and when a new call arrives verify that the voice used in it does not appear in the database more than a certain threshold of times. This prevents adversaries from using human agents to perform the NSTs. Note that this method can also serve as an RTT.

An alternative embodiment if for the service provider to use the IP (Internet Protocol) address of the client in order to verify that not too many NSTs are being performed from the same address. (Preferably, the service provider should verify that the client is indeed located at that IP address, for example by providing the client with a unique URL to an address in a web site that is controlled by the server, providing this URL to no other client, and verifying that a actual connection is made to that URL). In addition, the server could enhance the identification process by using identifying properties of the client's machine, for example parameters sent in the HTTP protocol such as the operating system version or the browser version. In addition, if the service provider installs a client on the user's computer/device, the client could have personalized identifying features that enable to identify from which client each service request is generated.

### CONCLUSION

Accordingly, the reader will see that the invention can be used to prevent repeated access of automated agents to services via a communications network. It has the additional advantages in that

Human users, or even automated agents, can access the service a limited number of times;

Human users with disabilities, such as vision disabilities or cognitive disabilities, are able to access the service;

It is very costly to access the service a considerable number of times, since each access requires the use of a non-trivial resource, such as a new telephone line;

Even an adversary that employs human users in order to access the server a large number of times cannot accomplish this task without spending considerable resources;

Clients are not required to install and use any special client device or software.

Although the description above contains many specifications, these should not be construed as limiting the scope of the invention but rather as merely as providing illustrations of some of the presently preferred embodiments of this invention. Thus the scope of the invention should be determined by the appended claims and their legal equivalent, rather than by the examples given.

We claim:

1. A method for selectively accepting service requests from a client connected to a server by a communications network, comprising:
a. said server receiving an access request from said client;
b. said server obtaining identifying information of said client provided by a communications network;
c. said server retrieving information of previous service requests with same identifying information;
d. said server deciding whether said client is entitled to service, wherein the decision is based, at least in part, on said information of previous service requests with same identifying information;
e. said server accepting the service request if said client is entitled to service, and denying the service request otherwise;
whereby the server is able to limit the number of services granted to an automated agent operating the client.

2. The method of claim 1 wherein the server approves service to said client if the number of previous service requests with same identifying information, performed during a predetermined time period, is smaller than a predetermined threshold.

3. The method of claim 1 wherein the identifying information is provided by a telephone network.

4. The method of claim 3 wherein the identifying information of said client is a caller id data provided by a telephone network.

5. The method of claim 1 wherein the identifying information is provided by the network that is used for the service request.

6. The method of claim 1 further comprising the server sending to the client a sequence of characters and the client sending back this sequence to the server.

7. The method of claim 1 wherein the request is accepted only if the identifying information of said client is received within a predetermined length of time.

8. The method of claim 1 wherein the request is accepted only if a connection with the client is kept open for a predetermined length of time.

9. An apparatus for accepting service requests from a client connected to a server by a network, comprising:
a. means for said server to receive identifying information of said client;
b. storage means for storing data of previous service requests and corresponding identifying information of clients;
c. means for deciding if said client is entitled to service, wherein the decision is based, at least in part, on data about previous service requests with same identifying information stored in said storage means, and type of service request;
d. means for accepting the service request if said client is entitled to service, and otherwise denying the service request;
whereby the server is able to limit the number of services granted to an automated agent operating the client.

10. The apparatus of claim 9 wherein the service request is accepted if the number of previous service requests with same identifying information, performed during a predetermined time period, is smaller than a predetermined threshold.

11. The apparatus of claim 9 wherein the identifying information is provided by a telephone network.

12. The apparatus of claim 11 wherein the identifying information of said client is a caller id data provided by a telephone network.

13. The apparatus of claim 9 wherein the identifying information is provided by the network that is used for the service request.

14. The apparatus of claim 9 further comprising means for sending to the client a sequence of characters and receiving from the client a message containing this sequence.

15. The apparatus of claim 9 wherein the request is accepted only if the identifying information of said client is received within a predetermined length of time.

16. The apparatus of claim 9 wherein the request is accepted only if a connection with the client is kept open for a predetermined length of time.

17. A computer program package for selectively accepting service requests, the computer program package providing instructions, which, if executed by a computer system, cause the system to perform operations comprising:
a. receiving a service request in a server computer from a client;
b. receiving identifying information of said client;
c. counting number of previous service requests with identifying information equal to identifying information of said client, which occurred during a predetermined time period;
d. deciding whether to accept service request, wherein the decision is based, at least in part, on whether said number of previous service requests is not greater than a predetermined threshold.

18. The computer program package of claim 17 wherein the identifying information is provided by a telephone network.

19. The computer program package of claim 17 further comprising means for sending to the client a sequence of characters and receiving from the client a message containing this sequence.

20. The computer program package of claim 17 wherein the request is accepted only if the identifying information of said client is received within a predetermined length of time.
